(19) United States
(12) Patent Application Publication
(10) Pub. No.: US 2009/0140982 A1
(43) Pub. Date: Jun. 4, 2009

(54) NAVIGATION INPUT MECHANISM, ELECTRONIC DEVICE INCLUDING THE SAME AND METHOD FOR SWITCHING MODE THEREOF

(75) Inventors: Ming-Yu Chen, Taoyuan (TW); Chih-Shan Yeh, Taoyuan (TW); Chao-Yi Chen, Taoyuan (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HTC Corporation, Taoyuan County (TW)

(21) Appl. No.: 12/193,957

(22) Filed: Aug. 19, 2008

(30) Foreign Application Priority Data
Nov. 29, 2007 (TW) 096145432

(51) Int. Cl. G06F 3/033; G05B 19/00

(52) U.S. Cl. 345/160; 340/5.82; 340/5.83

(57) ABSTRACT

A navigation input mechanism is provided. The navigation input mechanism is disposed on an electronic device. The navigation input mechanism further includes a switch sheet and a biometric recognition module. The switch sheet has a first penetrating hole and includes a plurality of switches. The switches are disposed on an upper surface of the switch sheet and surround a peripheral region of the first penetrating hole. The biometric recognition module includes a sensing unit. The sensing unit, capable of reading a biometric recognition signal, is accommodated in the first penetrating hole, and the upper surface of the sensing unit is exposed outside the first penetrating hole.

This application claims the benefit of Taiwan application Serial No. 96145432, filed Nov. 29, 2007, the subject matter of which is incorporated herein by reference.

### BACKGROUND OF THE INVENTION

1. Field of the Invention

The invention relates in general to a navigation input mechanism, an electronic device including the same and a method for switching a mode thereof, and more particularly to a navigation input mechanism integrated with a biometric recognition module, an electronic device including the same and a method for switching a mode thereof.

2. Description of the Related Art

Electronic devices, especially portable electronic devices such as personal digital assistants (PDA), mobile phones and laptop computers, are very common products nowadays. In order to operate the electronic device more easily, different keys, such as direction keys, number keys and a confirmation key, are disposed on the cover of the electronic device.

Because important information is often stored in the electronic device, some electronic devices have a biometric recognition module, such as a fingerprint identification device, to protect the information. Through a biometric recognition module to read the unique features that an individual has, a user's identity has to be confirmed before he can use the electronic device. Therefore, the important information stored in the electronic device is not leaked to hackers or to others when the electronic device is lost.

Furthermore, most users set a long password to enter the operation mode. When having many electronic devices, most users set a different password for each electronic device. However, it is easy to forget passwords by just memorizing them. It would be much more convenient to replace passwords with the biometric recognition technology. The user no longer needs to memorize the passwords, and of course does not need to worry about forgetting them.

The biometric recognition module occupies considerable space in the electronic device. It is quite inconvenient whether the biometric recognition module is disposed on the front side or the back side of the electronic device. Under this circumstance, the complexity of arranging other keys in the electronic device is increased, and the size of the electronic device cannot be reduced. Some electronic devices need an independent peripheral for performing the function of biometric recognition. However, it is still very inconvenient to use an independent peripheral though the volume of the electronic device is not increased in this way.

### SUMMARY OF THE INVENTION

The invention is directed to a navigation input mechanism integrated with a biometric recognition module, an electronic device including the same, and a method for switching the mode thereof. A biometric recognition module and a navigation input mechanism are integrated so that the space of the electronic device can be used more effectively, and it is more convenient to use the electronic device.

According to a first aspect of the present invention, a navigation input mechanism is provided. The navigation input mechanism is disposed on an electronic device, and includes a switch sheet and a biometric recognition module. The switch sheet has a first penetrating hole, and includes a plurality of switches. The switches are disposed on an upper surface of the switch sheet, and surround a peripheral region of the first penetrating hole. The biometric recognition module includes a sensing unit accommodated in the first penetrating hole. An upper surface of the sensing unit is exposed outside the first penetrating hole. The sensing unit is for reading a biometric recognition signal.

According to a second aspect of the present invention, an electronic device is provided. The electronic device includes a screen, a processing unit and a navigation input mechanism. The screen is for displaying an image. The processing unit is electrically coupled to the screen. The navigation input mechanism includes a switch sheet and a biometric recognition module. The switch sheet has a first penetrating hole and includes a plurality of switches. The switches are disposed on an upper surface of the switch sheet, and surround a peripheral region of the first penetrating hole. The biometric recognition module includes a sensing unit accommodated in the first penetrating hole. An upper surface of the sensing unit is exposed outside the first penetrating hole. The sensing unit is for reading a biometric recognition signal. The processing unit performs identity recognition according to the biometric recognition signal.

According to a third aspect of the present invention, a method for switching the mode of an electronic device is provided. First, an electronic device is activated so that a biometric recognition module enters a biometric recognition mode. The electronic device includes a navigation input mechanism and a processing unit. The navigation input mechanism includes a switch sheet and a biometric recognition module. The biometric recognition module includes a sensing unit. The sensing unit is disposed in a penetrating hole of the switch sheet. The switch sheet includes a plurality of switches disposed on an upper surface of the switch sheet, and the switches surround a peripheral region of the first penetrating hole. In the biometric recognition mode, the biometric recognition module reads a biometric recognition signal, and the processing unit performs identity recognition according to the biometric recognition signal. When the identity is confirmed, the biometric recognition module is switched to an operation mode. In the operation mode, the biometric recognition module reads an operation signal. The processing unit controls a function of the electronic device, or controls browsing the content of an image of the electronic device according to the operation signal.

The invention will become apparent from the following detailed description of the preferred but non-limiting embodiments. The following description is made with reference to the accompanying drawings.

### BRIEF DESCRIPTION OF THE DRAWINGS

FIG. 1 illustrates an electronic device according to a first embodiment of the present invention.

FIG. 2 is a block diagram of an embodiment depicting the system of the electronic device in FIG. 1.

FIG. 3 is an exploded view of a navigation input mechanism according to a second embodiment of the present invention.

FIG. 4 illustrates a partial structure of a sensing unit exposed outside a second penetrating hole.

FIG. 5 is a flow chart of a method for switching the mode of the electronic device according to an embodiment of the present invention.

### DETAILED DESCRIPTION OF THE INVENTION

Please refer to FIG. 1. FIG. 1 illustrates an electronic device according to a first embodiment of the present invention. As shown in FIG. 1, the electronic device 100, such as a mobile phone, a personal digital assistant (PDA), a portable computing device or a multimedia player, includes a screen 110 and a navigation input mechanism 120. The navigation input mechanism 120 includes a sensing unit 1231 for reading a biometric recognition signal. The sensing unit 1231 is disposed in a penetrating hole of the navigation input mechanism 120. Accordingly, a user can utilize the navigation input mechanism 120 to conveniently perform identity recognition on the electronic device 100, operate the electronic device 100, or control browsing the content on the screen 110. As a result, a more effective space usage can be achieved within the electronic device and additional disposition of a sensor becomes unnecessary.

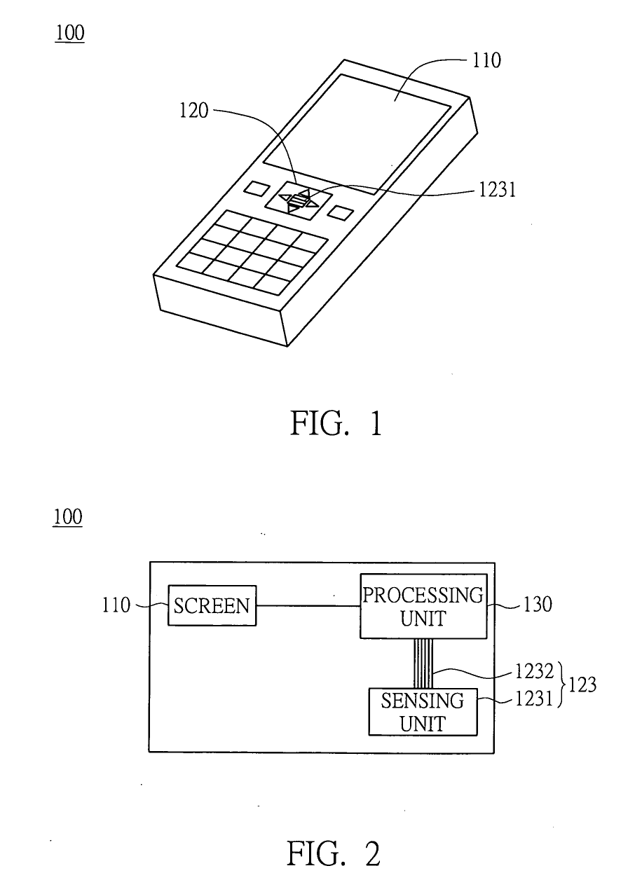

Please refer to FIG. 2. FIG. 2 is a block diagram of the system of the electronic device in FIG. 1 according to an embodiment. As shown in FIG. 2, the processing unit 130 is electrically coupled to the screen 110 which is used for displaying an image. The sensing unit 1231 communicates with the processing unit 130 through a flexible printed circuit 1232.

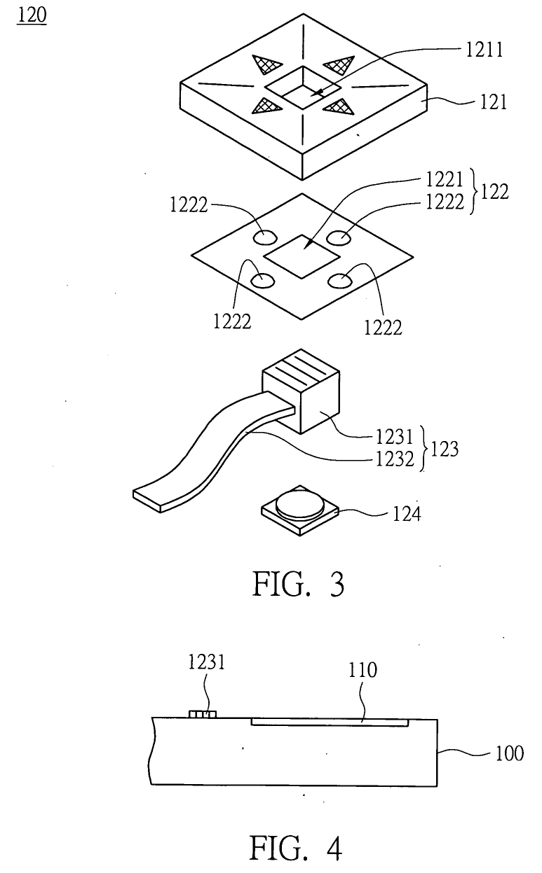

Many other embodiments of the navigation input mechanism 120 can be obtained based on the first embodiment in FIG. 1. For example, FIG. 3 is an exploded view of a navigation input mechanism according to a second embodiment of the present invention. As shown in FIG. 3, the navigation input mechanism 120 includes a cover 121, a switch sheet 122, a biometric recognition module 123 and a switch 124. The difference between the navigation input mechanism of the present embodiment and that of the first embodiment is that in the present embodiment, the biometric recognition module 123 is disposed on the switch 124, wherein the biometric recognition module 123 includes the sensing unit 1231. In this way, the biometric recognition module 123 and the other components of the navigation input mechanism 120 are integrated so that new operating methods and functions can be created. The integrated navigation input mechanism 120 is not only for identity recognition, but also controls a function of the electronic device or controls browsing the content displayed on the screen 110. The integrated navigation input mechanism 120 allows a user to have better user's experience, and creates a variety of operational functions. The switch 124 in the present embodiment is for example an elastic conductive switch, a metal dome switch, a mechanical switch or an electrical switch.

The switch sheet 122 has a first penetrating hole 1221, and includes four switches 1222. The four switches 1222 are disposed on an upper surface of the switch sheet 122, and surround a peripheral region of the first penetrating hole 1221. The cover 121 is disposed over the switch sheet 122, and covers four switches 1222. Practically, the switch sheet 122 is preferably a membrane switch or a complex switch having a printed circuit board (PCB). In other examples, the switch sheet is a hollow annular component (for example, a hollow wheel) or formed by several components assembled together. The switches 1222 are disposed on the switch sheet 122 according to the arrangement of the switch sheet 122.

The biometric recognition module 123 includes a sensing unit 1231 and a flexible printed circuit 1232. The sensing unit 1231 is accommodated in the first penetrating hole 1221, and is used to read a biometric recognition signal. The switch 124 is disposed under the sensing unit 1231. The processing unit 130 performs identity recognition according to the biometric recognition signal.

As shown in FIG. 2, the sensing unit 1231 is electrically coupled to the processing unit 130. For example, the sensing unit 1231 is electrically coupled to the processing unit 130 through the flexible printed circuit 1232. The flexible printed circuit 1232 is for transmitting signals between the sensing unit 1231 and the processing unit 130. Regarding the biometric recognition module 123, such as a fingerprint identification device, when the electronic device 100 is started up, the user is required to perform identify recognition with a fingerprint, the user touches the sensing unit 1231 with the finger, and the sensing unit 1231 sends the sensed biometric recognition signal to the processing unit 130 through the flexible printed circuit 1232. The processing unit 130 performs identity recognition according to this biometric recognition signal. Once the identity of the user is confirmed, the electronic device 100 enters the operation mode. In addition to the fingerprint identification device, in other examples, the biometric recognition module 123 can be an identification device associated with a characteristic of the finger, such as a vein identification device. In further examples, the biometric recognition module 123 can be an identification device for identifying other human characteristics not limiting to the hand, such as a voice identification device or an identification device for identifying characteristics of the eye, such as an iris identification device.

In the second embodiment, the cover 121 covers the four switches 1222. The navigation input mechanism is a 4-way navigation input mechanism. The four directions are up, down, left and right respectively, and they correspond to the four switches 1222, respectively. When one side of the cover 121 is pressed, the corresponding switch 1222 is also pressed. Therefore, the user can select a function option in the up, down, left or right direction, and confirms a selection. Preferably, the upper surface of the cover 121 includes signs (such as arrows) corresponding to the four directions, for clearly indicating the browsing direction. In the present embodiment, the navigation input mechanism is 4-way. However, the present invention is not limited thereto. In other embodiments, the navigation input mechanism can be a 2-way navigation input mechanism or an 8-way navigation input mechanism, wherein the number of the switches 1222 corresponds to the number of directions.

When the sensing unit 1231 is pressed, the switch 124 is pressed correspondingly to perform a function of the electronic device 100, such as performing an enter function. For example, the user uses the cover 121 to select a function option of the electronic device 100, and presses the sensing unit 1231 with the finger after a selection is made. At the same time, the corresponding switch 124 is pressed so that the corresponding function is performed.

Please refer to FIG. 4. FIG. 4 illustrates a partial structure of the sensing unit 1231 exposed outside a second penetrating hole 1211. The cover 121 has the second penetrating hole 1211. The sensing unit 1231 is accommodated in the second penetrating hole 1211, and the upper surface of the sensing unit 1231 is exposed outside the second penetrating hole 1211. As a result, the user can touch the sensing unit 1231 directly by the finger.

The sensing unit 1231 is not only for performing biometric recognition but also for controlling browsing the content of an image on the screen 110. When an operation signal is input, for example, by sliding the finger on the sensing unit 1231, pressing or continuously pressing the sensing unit 1231, the processing unit 130 controls a corresponding function of the electronic device 100 or controls browsing the content of an image on the screen 110 according to the operation signal. For example, the user uses the cover 121 to select a function of the electronic device 100, and presses the sensing unit 1231 twice by the finger after the selection is made. After receiving this signal, the sensing unit 1231 sends it to the processing unit 130, and the processing unit 130 performs the corresponding function. In another example, the user slides the finger on the sensing unit 1231. After receiving this signal, the sensing unit 1231 sends it to the processing unit 130, and the processing unit 130 scrolls down the content of the screen 110 accordingly for browsing the content of an image on the screen.

The biometric recognition module 123 is not separated from the space where the conventional navigation key exists, but exists in the same space where the cover 121 and the switch sheet 122 are existent and forms an integrated structure of the navigation input mechanism 120. Therefore, the space is saved and the volume of the electronic device 100 can be reduced. In addition, other keys of the electronic device 100 can be arranged with less limitation.

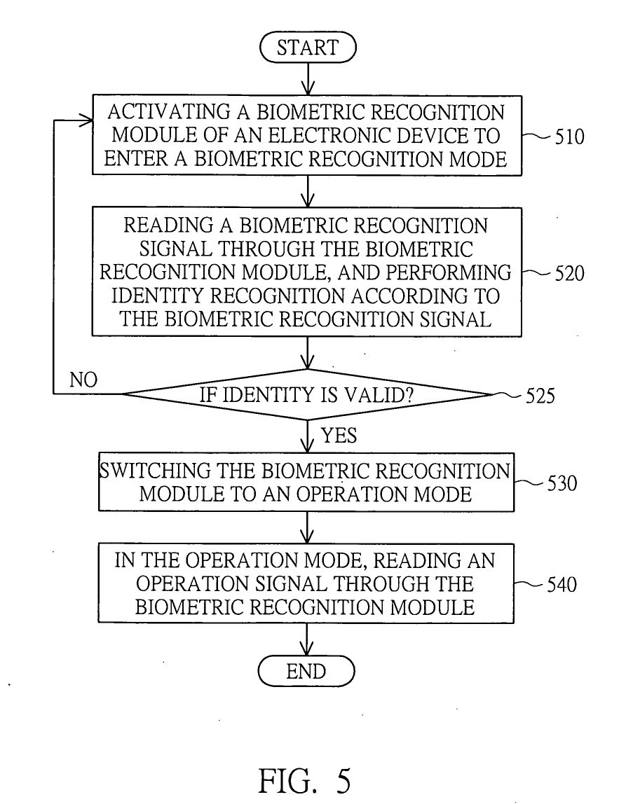

Please refer to FIG. 5. FIG. 5 is a flow chart of a method for switching the mode of an electronic device according to an embodiment of the present invention. The method for switching the mode of the electronic device in FIG. 5 includes following steps.

In a step 510, the biometric recognition module 123 of the navigation input mechanism of the electronic device 100 according to the first or second embodiment is activated to enter a biometric recognition mode.

Next, in a step 5207 in the biometric recognition mode, the biometric recognition module 123 reads a biometric recognition signal, and the processing unit 130 performs identity recognition according to the biometric recognition signal.

Then, in a step 525, when the identity is confirmed, the method proceeds to a step 530. Otherwise, another processing step is performed. For example, the step 510 is repeated as shown in FIG. 5. In another example, after several trials are failed, the same user is refused to be identified again.

Afterward, in a step 530, in an operation mode, an operation signal is read through the biometric recognition module 123. The processing unit 130 controls the function of the electronic device 100 or controls browsing the content of an image of the electronic device 100.

What is worth mentioning is that the user can be required to input the biometric recognition signal when the electronic device 100 is booting. Alternatively, the processing unit 130 can require the user to confirm the identity during the operation of the electronic device 100.

The navigation input mechanism, the electronic device including the same and the method for switching the mode thereof according to the above embodiments of the present invention include several advantages. Some of them are described as follow.

First, the sensing unit and the biometric recognition module are existent in the same space and form a navigation input mechanism. The space of the electronic device is saved, so the volume of the electronic device can be reduced. Other keys are disposed on the electronic device with fewer limitations in space.

Second, the sensing unit is not only for identity confirmation, but is also for controlling the function of the electronic device or controlling browsing the content of an image of the electronic device. The navigation input mechanism and the biometric recognition module are integrated in the same space, and thus the user can complete identity recognition and control the electronic device at the same place. As a result, it is more convenient to use the electronic device.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A navigation input mechanism disposed on an electronic device, the navigation input mechanism comprising:
a switch sheet having a first penetrating hole and comprising:
a plurality of switches disposed on an upper surface of the switch sheet and surrounding a peripheral region of the first penetrating hole; and
a biometric recognition module comprising:
a sensing unit accommodated in the first penetrating hole, for reading a biometric recognition signal, wherein an upper surface of the sensing unit exposed outside the first penetrating hole.

2. The mechanism according to claim 1 further comprising:
a switch disposed under the sensing unit;
wherein when the sensing unit is pressed, the switch is pressed correspondingly so as to control a function of the electronic device.

3. The mechanism according to claim 2, wherein the biometric recognition module further comprises:
a flexible printed circuit electrically coupled to the sensing unit for transmitting a signal.

4. The mechanism according to claim 2 further comprising:
a cover disposed over the switch sheet and covering the switches, the cover having a second penetrating hole, the sensing unit accommodated in the second penetrating hole, the upper surface of the sensing unit also exposed outside the second penetrating hole;
wherein the switches are pressed selectively when the cover is pressed.

5. The mechanism according to claim 1 further comprising:
a cover disposed over the switch sheet and covering the switches, the cover having a second penetrating hole, the sensing unit accommodated in the second penetrating hole, the upper surface of the sensing unit also exposed outside the second penetrating hole;
wherein the switches are pressed selectively when the cover is pressed.

6. The mechanism according to claim 1, wherein the biometric recognition signal is generated by touching the sensing unit with a finger.

7. The mechanism according to claim 1, wherein the sensing unit is able to read an operation signal to communicate with the electronic device.

8. The mechanism according to claim 7, wherein the operation signal is generated by sliding a finger on the sensing unit, pressing or continuously pressing the sensing unit.

9. The mechanism according to claim 1, wherein the biometric recognition module is a fingerprint identification device, an iris identification device or a voice identification device.

10. An electronic device comprising:
a screen for displaying an image;
a processing unit electrically coupled to the screen; and
a navigation input mechanism comprising:
a switch sheet having a first penetrating hole and comprising:
a plurality of switches disposed on an upper surface of the switch sheet and surrounding a peripheral region of the first penetrating hole; and
a biometric recognition module comprising:
a sensing unit accommodated in the first penetrating hole, an upper surface of the sensing unit exposed outside the first penetrating hole, the sensing unit electrically coupled to the processing unit for reading a biometric recognition signal;
wherein the processing unit performs identity recognition according to the biometric recognition signal.

11. The device according to claim 10, wherein the navigation input mechanism further comprises:
a switch disposed under the sensing unit;
wherein when the sensing unit is pressed, the switch is pressed correspondingly for controlling a function of the electronic device.

12. The device according to claim 11, wherein the navigation input mechanism further comprises:
a flexible printed circuit electrically coupled to the sensing unit and the processing unit for transmitting signals between the sensing unit and the processing unit.

13. The device according to claim 11, wherein the navigation input mechanism further comprises:
a cover disposed over the switch sheet and covering the switches, the cover having a second penetrating hole, the sensing unit accommodated in the second penetrating hole, the upper surface of the sensing unit exposed outside the second penetrating hole;
wherein the switches are pressed selectively when the cover is pressed.

14. The device according to claim 10, wherein the navigation input mechanism further comprises:
a cover disposed over the switch sheet and covering the switches, the cover having a second penetrating hole, the sensing unit accommodated in the second penetrating hole, the upper surface of the sensing unit exposed outside the second penetrating hole;
wherein the switches are pressed selectively when the cover is pressed.

15. The device according to claim 10, wherein the biometric recognition signal is generated by touching the sensing unit with a finger.

16. The device according to claim 10, wherein the sensing unit is further for reading an operation signal, and the processing unit controls the function of the electronic device or controls browsing the content of an image of the electronic device according to the operation signal.

17. The device according to claim 16, wherein the operation signal is generated by sliding a finger on the sensing unit, pressing or continuously pressing the sensing unit.

18. The device according to claim 10, wherein the biometric recognition module is an identification device associated with a characteristic of a finger.

19. The device according to claim 10, wherein the electronic device is a hand-held communication device or a hand-held computing device.

20. A method for switching the mode of an electronic device, the method comprising:
(a) activating a biometric recognition module of the electronic device to enter a biometric recognition mode, wherein the electronic device comprises a navigation input mechanism and a processor, the navigation input mechanism comprises a switch sheet and a biometric recognition module, the biometric recognition module comprises a sensing unit disposed in a penetrating hole of the switch sheet, and the switch sheet comprises a plurality of switches disposed on an upper surface of the switch sheet and surrounding a peripheral region of the first penetrating hole;
(b) in the biometric recognition mode, reading a biometric recognition signal by the biometric recognition module, and performing identity recognition by the processing unit according to the biometric recognition signal; if an identity is correctly confirmed, proceeding to step (c); otherwise, repeating step (a);
(c) switching the biometric recognition module to an operation mode; and
(d) in the operation mode, reading an operation signal through the biometric recognition module, wherein the processing unit controls a function of the electronic device or controls browsing the content of an image of the electronic device according to the operation signal.

21. The method according to claim 20, wherein the electronic device is a hand-held communication device or a hand-held computing device.

22. The method according to claim 20, wherein the biometric recognition module is an identification device associated with a characteristic of a finger or an eye.

23. The method according to claim 20, wherein the biometric recognition signal is generated by touching the sensing unit with a finger.

24. The method according to claim 20, wherein the operation signal is generated by sliding a finger on the sensing unit, pressing or continuously pressing the sensing unit.
